(19) United States
(12) Patent Application Publication
(10) Pub. No.: US 2008/0244049 A1
(43) Pub. Date: Oct. 2, 2008

(54) Method and System for Device Management

(76) Inventors: Magnus Normark, Bromma (SE); Britt-Mari Svensson, Sollentuna (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/599,213

(22) PCT Filed: Jul. 13, 2005
(86) PCT No.: PCT/SE2005/001157

§ 371 Date: Sep. 22, 2006

(30) Foreign Application Priority Data
Aug. 25, 2004 (SE) 0402091-3

(51) Int. Cl. G06F 15/16

(52) U.S. Cl. 709/223

(57) ABSTRACT

The device management is performed by managing objects in devices of a device management system in a mobile network infrastructure. The system has a first server with a first device management application using a first protocol, a second server with a second device management application using a second protocol, an interface between them and a device with objects to be managed. The first management application initiates a device management session with the interface in order to manage the objects in the device. The interface translates the objects to be managed into a form understood by the second management application and invokes management operations to be made by the second management application. The first management application then performs the management operations to the device.

### TECHNICAL FIELD

The invention is concerned with a method and system for managing objects in devices in a device management system in a mobile network infrastructure. The system comprises a first server with a device management application using a first protocol and a second server with a device management application using a second protocol.

### BACKGROUND

GSM, together with other technologies, is part of an evolution of wireless mobile telecommunication. The Global System for Mobile Communication (GSM) is a standard for digital wireless communications with different services, such as voice telephony. The Subscriber Identity Module (SIM) inside GSM phones was originally designed as a secure way to connect individual subscribers to the network but is nowadays becoming a standardized and secure application platform for GSM and next generation networks.

The Mobile Station (MS) represents the only equipment the GSM user ever sees from the whole system. It actually consists of two distinct entities. The actual hardware is the Mobile Equipment (ME), which consists of the physical equipment, such as the radio transceiver, display and digital signal processors. The subscriber information is stored in the Subscriber Identity Module (SIM), implemented as a Smart Card. With respect to the terminology used in this document, The Mobile Station (MS) includes the Mobile Equipment (ME) and the Subscriber Identity Module (SIM). The term “Handset” is used as a synonym to the Mobile Equipment (ME) and the term “Device” as a synonym to The Mobile Station (MS).

The mobile equipment is uniquely identified by the International Mobile Equipment Identity (IMEI) being a unique code that corresponds to a specific GSM handset. The SIM card contains the International Mobile Subscriber Identity (IMSI), identifying the subscriber, a secret key for authentication, and other user information.

The term “device identity information” comprises in the context of this document both equipment information, such as the IMEI, and subscriber information, such as the MSISDN or IMSI. The IMEI and the IMSI or MSISDN are, however, independent and can thereby provide personal mobility.

The Mobile Station Integrated Service Digital Network Number, MSISDN, is the standard international telephone number used to identify a given subscriber. The operator declares the subscription in a database inside the network, which holds the correspondence between the IMSI and the MSISDN. By inserting the SIM card into another GSM terminal, the user is able to receive and make calls from that terminal, and receive other subscribed services.

A device management session includes e.g. authentication (user verification), device inventory (a device management application read which parameters and applications are installed in the telephone for future decisions, such as e.g. updating, adding and deleting things from the installations), continuous provisioning (a device management application e.g. updates parameters on the telephone device, sends applications to the device, performs software and firmware updates), device diagnostics (error finding), etc.

Sending new settings over the air is one simple way to provision a device with configuration parameters, such as connectivity information (device settings). After receiving the settings to configure the phone, the customer simply saves them to the phone and is then able to use the services. For the operator, simplifying access to advanced services can bring higher usage rates, new revenue streams, and reduced customer helpline costs.

As a result of technological development, networked and mobile/wireless devices are becoming more and more complex, and consequently, connected devices are also becoming more and more difficult to manage. Device management standardization is an on-going issue. The SyncML initiative has identified the complexity of this issue, and the importance for finding a universal solution for a device management protocol. SyncML is the open standard that drives data mobility by establishing a common language for communications between devices, applications and networks.

Device management allows third parties to configure mobile devices on behalf of the end users. There are numerous cases, wherein device management is needed such as new device purchase, remote service management, software download, changing and adding services, and service discovery and provisioning etc. Device management applications are typically used by mobile service providers. They are used for customer care purposes and to increase revenue by effective value added service management.

SyncML Device Management (SyncML DM) is a device management protocol for management of devices and applications, simplifying configuration, updates and support.

SyncML Device Management Protocol (SyncML DM) is thus a standard for communication between devices and device management server systems. The standardization body is OMA, Open Mobile Alliance. The device to be managed is equipped with a SyncML DM user agent in the device (i.e. terminal or handset) that speaks the SyncML DM language.

However, as was stated above, a mobile station often consists of two entities: the subscriber identity module (SIM) and the mobile equipment (ME). In a device management environment both entities that makes up the “device” are of interest. Both those entities need to be subjects of device management operations.

Device management operations towards the SIM card are to a certain extent proprietary. Over-the-air secure transport is specified for example by GSM SMS point-to-point and “03.48” (Security mechanisms for the SIM application toolkit). However the formatting of the device management commands and the access conditions to the SIM files are card type (vendor) proprietary. However, many existing SIM cards use proprietary protocols for secure transport. Thus, protocols may be both vendor proprietary and/or standardised depending on the individual handset and SIM card models. That in turn implies the need for several device management protocols in the device management environment in order to manage the device as a whole. The need for a multi-protocol device management environment stems therefore from the fact that the mobile devices of concern comprise data entities residing both on the SIM card and in the handset itself.

Data entities residing in the handset (i.e. Mobile Equipment (ME)) are represented by standardized Managed Objects (MO) as specified by the SyncML DM protocol. The protocol specifies how the MOs may be managed (i.e. read, updated, deleted . . . ) by a remote server side component. For more information reference is made to the standard “SyncML Device Management Standardized objects” version 1.1.2.

Data entities residing in the SIM card, in turn, are represented by a logical structure of files. This structure is hierarchical and there are three types of files, i.e. Elementary Files (EF), Dedicated Files (DF) and Master Files (MF), the last mentioned ones being highest in the hierarchy. More details about SIM files can be found in the GSM standard ETSI TS 100 977 V8.2.0.

The SIM files can be remotely managed by standardized commands for Remote File Management (RFM). The access conditions for the files are, however, not standardized as these are under the control of the application manager in co-operation with the network operator or service provider owing the SIM. The access conditions may be dependent on the level of security applied to the SIM Data Download message. The parameter(s) in the SIM Data Download message is either a single command or a list of commands to be processed sequentially. Detailed information can be found in the GSM standard ETSI TS 101 181 V8.3.0.

The SIM card data and services are not manageable as objects that can be managed by the SyncML DM protocol. It is possible to specify them as SyncML DM managed objects (MOs), but the SyncML DM protocol does not specify how a SyncML DM user agent in the handset could manage the SIM.

### OBJECT OF THE INVENTION

The object of the invention is to develop improved methods and systems that enable management of the whole device, which comprises data entities residing both on the handset and the SIM.

### SUMMARY OF THE INVENTION

In the method of the invention device management is performed by managing objects in devices in a device management system in a mobile network infrastructure. The system comprises a first server with a first device management application using a first protocol, a second server with a second device management application using a second protocol, an interface between them and a device with objects to be managed. In the method, the first management application initiates a device management session with the interface in order to manage the objects in said device. The interface translates the objects to be managed into a form understood by the second management application and invokes management operations to be made by the second management application. The first management application then performs the management operations to said device.

The system of the invention manages objects in devices in a device management system in a mobile network infrastructure. The system of the invention comprises a first server with a device management application using a first protocol, a second server with a device management application using a second protocol, an interface between them implementing protocol conversion, a database storing mapping relationships between first protocol objects to be managed and second protocol objects to be managed, and a device with second protocol objects to be managed.

The preferable embodiments of the method of the invention are presented in the subclaims.

The invention that enables remote management of mobile devices that requires a multi-protocol device management environment.

In this document, the term SIM file management (SFM) is used for device management operations towards SIM cards. That includes both the Over-The-Air (OTA) transport and the formatting.

In this document, a system that is able to manage both the handset and the SIM card is referred to as a Unified Device Management system (UDM). In the scope of UDM, both the SIM residing and the terminal residing data, applications and software are of interest and must be managed.

By the invention, a UDM application may manage both handset and SIM by the SyncML DM protocol.

Said interface in the invention especially covers adaptive processes where SIM residing data and applications are presented as, and managed in the same way as OMA-DM managed objects (MOs) (OMA-DM protocol and SyncML-DM protocol mentioned earlier refers to the same protocol). This is achieved by an innovative mapping of data objects and device management operations from different technologies and protocols onto one desired protocol, like e.g. OMA-DM protocol.

The invented adaptive processes covred by the interface and embodied are referred to as the Adaptive Protocol Conversion (APC) system in this document forward. The APC system in the invention makes sure that a device management application, on user level, can implement a device management application, using only the desired protocol, such as the OMA-DM (SyncML DM) protocol.

Seen from the point of view of a device management application, the mobile device that comprises two entities that requires different device management protocols, can be managed as one uniform logical entity by, in practice, only one device management protocol.

By the invented method and system, a unified single-protocol device management application development environment is exposed. That way the application level development of device management use-cases can be done simply by one and the same device management protocol. Whatever conversions and data mapping required to manage the SIM card is handled “under the surface” by the invented method and system. The prefered embodiment of the method and system of the invention is where the unified application development environment takes place over a standardised device management protocol such as OMA-DM (SyncML-DM).

In the invention, gateway features facilitate adaptive protocol conversion, including data entity mapping according to strictly applied dedicated device descriptions and proxy features facilitating device management sessions between device management components (i.e. clients and servers) that are not using one and the same device management protocol.

The system comprises a dedicated gateway/proxy application program and database.

To summarize, by the invention, a device management application may manage data entities residing both in the handset and on the SIM by the OMA-DM protocol.

In the following, the invention is described by means of some advantageous embodiments and figures, the details of which the invention is not restricted to.

### FIGURES

FIG. 1 is a view of a prior art target environment without the invention

FIG. 2 is a view of an environment that includes the entities that implements the method of the invention

FIG. 3 is a signal diagram of the method of the invention

FIG. 4 displays a schematic view of the conversion map between SIM files and managed objects

### DETAILED DESCRIPTION

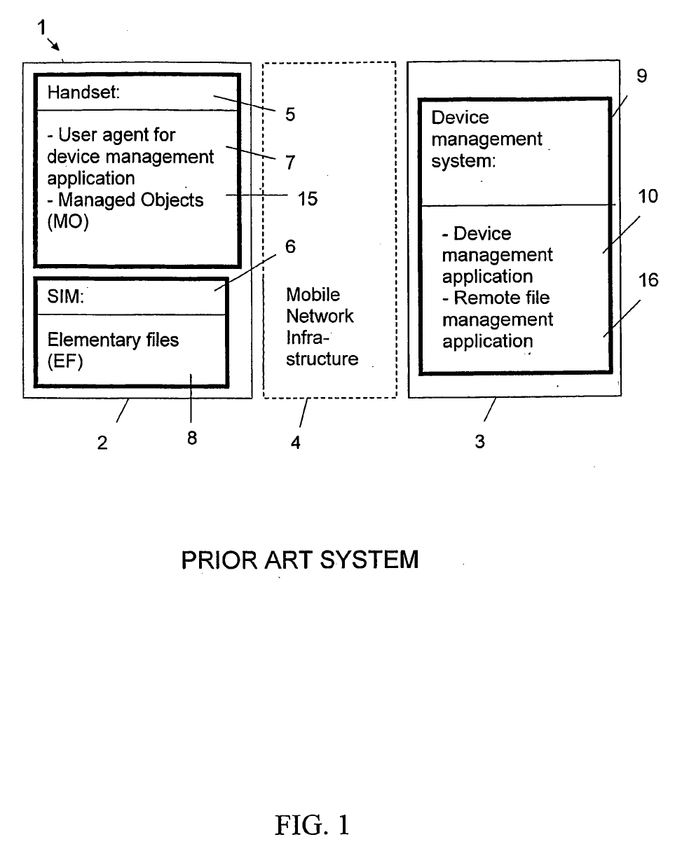

FIG. 1 is a view of a prior art target environment without the invention. The target environment is presented as an example of a telecommunication network 1 in which the invention can be used. The telecommunication network 1 comprises one or more devices to be managed, of which one device 2 and a device management server 3 can be seen in FIG. 1. The device 2 to be managed is in this example a mobile device 2 belonging to the mobile network infrastructure 4.

The Mobile Station (MS) (=The device) represents the only equipment the GSM user ever sees from the whole system. It actually consists of two distinct entities. The actual hardware is the Mobile Equipment (ME) (=handset) marked with reference number 5 in FIG. 1, which consists of the physical equipment, such as the radio transceiver, display and digital signal processors. The subscription information is stored in the Subscriber Identity Module (SIM), marked with reference number 6 in FIG. 1, implemented as a Smart Card.

In this context, the mobile network infrastructure includes all components and functions needed for mobile data communication, both GSM and internet included. The mobile device 2, in turn, includes both the handset 5 and the SIM card 6. Thus, the mobile device 2 has access to the mobile network infrastructure 4.

SyncML Device Management Protocol (SyncML DM) is one standard for communication between devices and applications in device management systems. If this standard is used, the device to be managed, i.e. the mobile station 2 in FIG. 1, is equipped with a SyncML user agent 7 in the device 2 that speaks the SyncML DM language. With other device management protocols, the user agent 7 is a user client for the particular device management application used in the device management system 9. The data entities residing in the handset 5 (i.e. Mobile Equipment (ME)) are represented by standardized Managed Objects (MO) 15. When the protocol used is SyncML DM, these are specified by the SyncML DM protocol.

The data entities residing in the SIM card, in turn, are represented by a logical structure of files, including the Elementary Files (EF) having reference number 8 in FIG. 1.

The SIM files 8 can be remotely managed by standardized commands for remote file management by means of a standardized remote file management application 16, such as RFM, in the device management system 9. The device management system 9 of FIG. 1 also has a device management application 10 for managing the managed objects (MO) 15 using a device management protocol, which e.g. can be SyncML DM, which is typically used by mobile service providers. The applications 10, 16 are in reality on different servers and thus the server 3 has to be considered as a common expression for applications on server side. The applications are used for customer care purposes and to increase revenue by effective value added service management.

Thus, in summary, the mobile device 2 of FIG. 1 comprising the handset 5 and the SIM card 6 is subject of device management in a multi-protocol mobile device management environment. The data entities 15, i.e. the managed objects, in the handset are then manipulated by management operations carried over a standardized protocol, i.e. the SyncML-DM protocol in this example. The user agent 7 is the client side component required to carry out device management operations over the SyncML-DM protocol. The data entities 8, i.e. the elementary files, in the SIM card may in turn be manipulated by management operations carried over Remote File Management (RFM) protocols. The data entities, MO's and EF's, may not be managed over the same device management protocol.

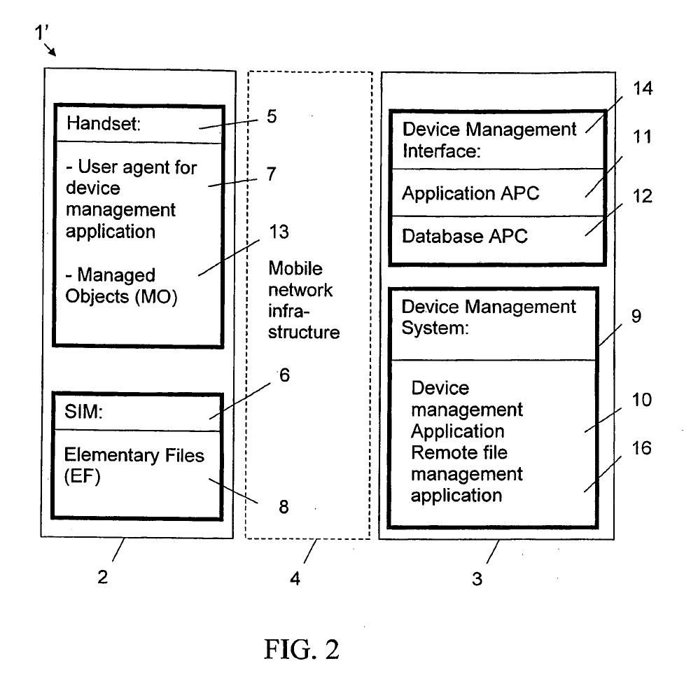

However, via the adaptive protocol conversion provided by the invention, by means of the APC system mentioned, the EF's are presented as manageable over the same protocol as the MO's. FIG. 2 is a view of an environment that includes the entities that implements the method of the invention in addition to those presented in FIG. 1. The system 1′ in FIG. 2 comprises components residing on both the mobile device 2 in FIG. 2 and on the server side 3 in FIG. 2. Again the server side in the reality consists of several servers, one for each device management application and one for the APC system interface. The server including the APC system interface 14 is an own server between the different device management applications 10,16 and the APC is in fact a tightly integrated client to SIM file management applications.

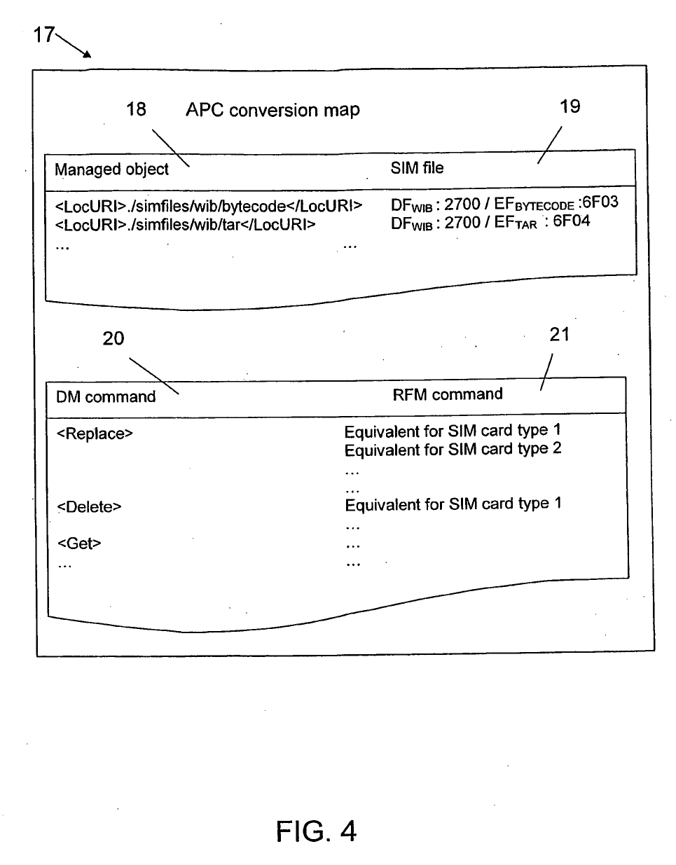

The APC interface comprises an APC application 11 and an APC database 12. The APC application 11 interprets the OMA-DM device management protocol and acts as the client side component on behalf of the mobile device during the management session. The APC application 11 communicates with the APC database 12 which is a conversion map and holding the relationship between managed objects 13 and elementary files 8. The APC database is presented more in detail in FIG. 4.

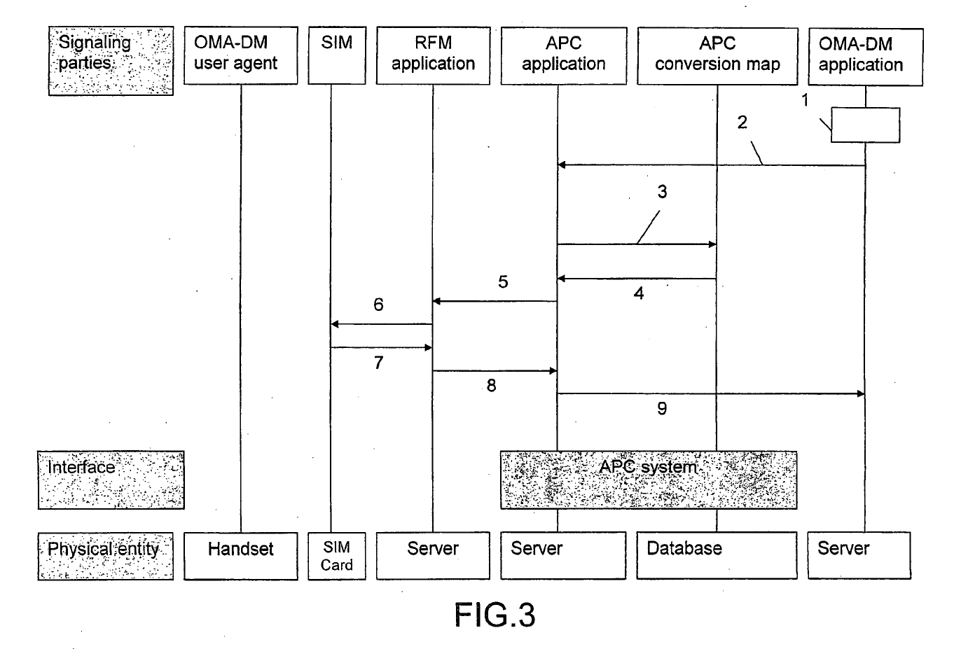

An example of an embodiment of the method of the invention is presented in form of a signal diagram in FIG. 3.

FIG. 3 shows on the lowest row, the physical entities taking part in the method of the invention. These are the handset, the SIM card, a server holding a remote file management application, a server holding the OMA-DM application and a server holding the APC interface with the APC application and the APC conversion map (APC database). All said servers are called with the common reference number 3 in FIG. 2. The APC system of the invention comprises the APC application (a server application in the APC interface) and the APC database (a server database). Further applications on the server-side are the RFM and OMA-DM applications.

FIG. 3 also displays the flow of events for an embodiment of the method of the invention in the form of device management transactions, wherein the OMA-DM application is performing managament transactions towards the SIM card and the APC system is involved to fascilitate the session.

The intention is now to read or update the value/contents of the elementary file EF_{BYTECODE} of a particular device by means of the OMA-DM application.

When the intention is to manage a specific SIM file, the OMA-DM application knows which MO it corresponds to as this appears in the Device Description, which is a part of the OMA-DM application. The conversion from the EF_{BYTECODE} to the corresponding managed Object (MO) is performed in step 1 of FIG. 3 by the OMA-DM application.

In the second step, signal 2 of FIG. 3, the OMA-DM application issues a device management operation via the APC application in form of a request to the APC application to read or update said MO, which was converted to in step 1.

The APC application then maps the data entity (that is the MO) represented by a URI, onto the correct EF file name by requesting in step 3 the relationship MO˜EF in the APC data entity conversion map and getting the information in step 4. URI is short for Uniform Resource Identifier, the generic term for all types of names and addresses that refer to objects on the World Wide Web. A URL is one kind of URI. Reference is made to RFC 2396 Request for Comments document for the Uniform Resource Identifiers (URI).

When the APC application knows what EF to address, it invokes a Remote File Management (RFM) transaction directly with the SIM card over-the-air. The RFM transaction is carried out via an RFM application (in step 5) that is able to format, encode and transmit Over-the-air device management transactions with the SIM card, which is performed in step 6.

Response from the SIM card is received in step 7 via the RFM application to the APC application (in step 8). Now the APC application converts back to the SyncML DM protocol, forwarding the response from the SIM card) and continues the session with the OMA-DM application (reference number 9). The experience from the OMA-DM application's view is that it stands in direct contact with the device (i.e. the SIM card) and manages it directly as were it manageable over OMA-DM device management protocol.

The APC system provides the adaptive protocol conversion features by exposing a device description of the SIM EF's accordin to the OMA-DM device description framework, and implementing the same in the ADC conversion map.

FIG. 4 displays a schematic view of the conversion map (reference number 17). The APC conversion map provides a lookup where SIM files (reference number 19) are mapped onto OMA-DM MO's (reference number 18). An OMA-DM MO is identified by a URI, whereas a SIM file is identified by a hexadecimal code (and an optional human readable file name). The conversion map also provides a lookup for protocol conversion. Device management commands included in the OMA-DM protocol (reference number 20) corresponds to an RFM protocol command (reference number 21) with the equivalent functional meaning.

Actually the protocol conversion is more complex than what is illustrated in FIG. 4. RFM protocol commands carried over-the-air are often SIM card type (vendor) proprietary. Therefore the APC conversion map holds information about the correct RFM protocol equivalent for a wide variety of SIM card types. A lookup in the APC conversion map requires that the SIM card type as an input parameter. The mapping of protocol command equivalents is not done one-to-one, instead one-to-many. This fact clearly illustrates the enormous benefit of the APC system in a mobile device management system.

1. Method for device management by managing objects in devices in a device management system in a mobile network infrastructure, the system comprising a first server with a first device management application using a first protocol, a second server with a second device management application using a second protocol, an interface between them and a device with objects to be managed, the method being
characterized by the following steps in combination
a) the first management application initiating a device management session with the interface in order to manage the objects in said device,
b) the interface translating the objects to be managed into a form understood by the second management application and invoking management operations to be made by the second management application,
c) the first management application performing the management operations to said device.

2. Method of claim 1, characterized by the further steps in which
d) the first management application responds to the interface,
e) the interface translates the objects to be managed into a form understood by the first management application, and
f) the first management application continues said device management session with the interface.

3. Method of claim 1, characterized in that the mobile network infrastructure comprises the GSM network and a public network, such as internet.

4. Method of claim 2, characterized in that the device with the objects to be managed is selected from a SIM card in a mobile station, a USIM card in a mobile station, a handset in a mobile station, and a smart card in a computer connected to a handset in a mobile station.

5. Method of any of claims 1-3, characterized in that the first device management application uses the SyncML DM protocol.

6. Method of claim 3 or 4, characterized in that the device with the objects to be managed is the SIM card in a mobile station and the second device management application uses a SIM File Management (SFM) protocol.

7. Method of any of claims 1-6, characterized in that in the translation of step b), the data objects to be managed are OMA-DM managed objects that are mapped onto data entities residing on SIM understood by a SIM File Management (SFM) protocol .

8. Method of claim 7 characterized in for each OMA-DM protocol command, the translation is performed by selecting the appropriate RFM protcol command equivalent based on the mobile device type, more specifically, the SIM card type.

9. Method of any of claims 1-8, characterized in that after step a), the interface checks the identity of the device by means of a subscription identity, such as IMSI or MSISDN, and handset identity, such as the IMEI from a repository in the infrastructure.

10. Method of claim 9, characterized in that the RFM protocol command includes also the selection of the transport channel.

11. Method of any of claims 1-10, characterized in that the interface translating the objects to be managed is an application making use of a conversion map holding the relationships between objects to be managed of different protocols.

12. System for managing objects in devices in a device management system in a mobile network infrastructure, the system comprising
a first server with a first device management application using a first protocol,
a second server with a second device management application using a second protocol,
an interface between them implementing protocol conversion,
a database storing mapping relationships between first protocol objects to be managed and second protocol objects to be managed, and
a device with second protocol objects to be managed.

13. System of claim 12, characterized in that the mobile network infrastructure comprises the GSM network and a public network, such as internet.

14. System of claim 12 or 13, characterized in that the device with the objects to be managed is selected from a SIM card in a mobile station, an USIM card in a mobile station, a handset in a mobile station, and a smart card in a computer connected to a handset in a mobile station.

15. System of claim 12, characterized in that said first protocol is the SyncML DM protocol.

16. System of claim 14 and 15, characterized in that the device with the objects to be managed is the SIM card in a mobile station and said second protocol is a SIM File Management (SFM) protocol.

17. System of any of claims 12-16, characterized in that the first protocol objects to be managed are managed Objects (MO) according to the SyncML DM protocol and the second protocol objects to be managed are SIM files according to a SIM File Management (SFM) protocol.
